(19) United States
(12) Patent Application Publication
(10) Pub. No.: US 2017/0259442 A1
(43) Pub. Date: Sep. 14, 2017

(54) SHEET MATERIAL APPLICATION TOOL AND METHOD

(71) Applicant: Geek Wraps, Inc., Oakland Park, FL (US)

(72) Inventors: Kenneth J. Calman, Fort Lauderdale, FL (US); Kathryn S. Calman, Fort Lauderdale, FL (US)

(21) Appl. No.: 15/455,876

(22) Filed: Mar. 10, 2017

Related U.S. Application Data
(60) Provisional application No. 62/389,854, filed on Mar. 10, 2016.

(51) Int. Cl. B26B 29/06; B29C 65/00; B29C 65/48

(52) U.S. Cl. CPC B26B 29/06; B29C 65/48; B29C 66/02241; B29L 2007/002

(57) ABSTRACT

A sheet material application tool, a method of cutting a sheet material, and a method of using a sheet material application tool are provided. The sheet material application tool includes at least one base portion having a first base gripping surface and a second base gripping surface. The tool further includes at least one edge portion extending substantially perpendicular to the second base gripping surface.

### RELATED APPLICATION DATA

This application claims the benefit of U.S. Provisional Application No. 62/389,854 filed Mar. 10, 2016, which is incorporated herein by reference in its entirety.

### FIELD OF THE DISCLOSED EMBODIMENTS

The present disclosure relates to the application of sheet materials and, more particularly, to sheet material application tool and method for applying sheet materials.

### BACKGROUND

Sheet materials, such as adhesive sheet materials, are becoming an increasingly popular choice for advertising or otherwise displaying graphics on signs, automobiles, indoor and outdoor walls, indoor and outdoor floors, indoor and outdoor ceilings, buildings, and numerous other surfaces. Sheet materials typically have a display side bearing desired graphics, colors, texture, images, and/or text, and an application side that is coated with an adhesive substance and allows for application to various surfaces. The sheet material is typically applied in oversized sections and then cut or shaped to a desired shape and size. The size of the oversized sections and the size of the surface to which the sheet material is being applied vary greatly depending on the application.

One type of sheet material, which is commonly used in the vehicle wrap industry is a vinyl paint wrap. Although vinyl paint wraps are common, vehicles can be customized using a variety of adhesive sheet materials and the customization can include, but is not limited to including, body color change, texture change, or the application of particular graphic images, text, or a combination thereof.

Sheet materials may be applied to surfaces that have a variety of unique features, such as contours, welded obstacles, edges, textures, and elements such as handles or windows. It is desirable to shape the sheet material around the surfaces' unique features. An adhesive sheet material generally is best applied after being gently heated during the application process, the heat serving both to activate the adhesive and to render the adhesive sheet material more pliable and thus more amenable to application to the surface and its unique features. Generally, a heat source, such as a propane or other combustible gas torch is used to heat the adhesive sheet material, although electric heating instruments may be used as well.

Application of adhesive sheet material is also a pressure-sensitive process. Applying too much or too little pressure can result in improper installation of the adhesive sheet material. Difficulties often arise during application of adhesive sheet material to variations in the surface or irregular surface features, such as contours, welded obstacles, edges, texture, and elements such as handles or windows. Issues can arise if too little, too much, or non-uniform pressure is applied when installing the adhesive sheet material to variations in the surface or irregular surface features. These issues include gaps, air bubbles, or air-pockets in-between the surface and the adhesive sheet material, as well as post application lifting of the adhesive sheet material from the surface caused by shrinkage of the adhesive sheet material after being overstretched. If the sheet material is not properly adhered to the surface, it can result in aesthetic problems, peeling off of the sheet material, and/or premature delamination from the sheet material causing future failure.

Currently, the art lacks a reliable and desirable apparatus and method for applying sheet material to variations in the surface or irregular surface features (especially around edges, in crevices, and at other surface features), applying the correct pressure, and preventing gaps, air bubbles, air-pockets, and lifting between the surface and the sheet material. Further, the art lacks a reliable and desirable apparatus and method for cleaning or otherwise accessing edges, crevices, and other irregular surface features of an application surface. Finally, the art lacks a reliable and desirable apparatus and method for trimming the sheet material at an edge of an application surface.

### SUMMARY

In accordance with an embodiment of the present disclosure, a sheet material application tool is provided. The tool includes at least one base portion having a first base gripping surface and a second base gripping surface and at least one edge portion extending substantially perpendicular to the second base gripping surface.

The at least one edge portion may include at least one edge spaced from the at least one base portion. The at least one base portion may include a first base end distal to the at least one edge portion, a second base end proximate to the at least one edge portion, and a central base portion disposed between the first base end and the second base end. The at least one base portion may include at least one blade accepter disposed at the second base end and configured to accept at least one blade member. The at least one base accepter may include a first blade accepter disposed at the second base end and configured to accept a first blade member and a second blade accepter disposed at the second base end and configured to accept a second blade member. The first blade member may be larger in size than the second blade member. At least one of the first blade accepter and the second blade accepter may be a slot through the sheet material application tool. The tool may further include at least one cover. The at least one cover may be secured over the first base end. The at least one cover may be sewn onto the at least one base portion.

In accordance with an embodiment of the present disclosure, a method of cutting sheet material adjacent an edge of an application surface is provided. The method includes providing a sheet material application tool having an edge portion and a blade accepter, positioning the edge portion of the sheet material application tool at the edge of the application surface, positioning a blade member at the blade accepter such that the blade member contacts the sheet material through the blade accepter of the sheet material application tool, and moving the sheet material application tool over the sheet material while the edge portion of the sheet material application tool remains at the edge of the application surface such that the blade member cuts sheet material at the application surface.

In accordance with an embodiment of the present disclosure, a method of using a sheet material application tool adjacent an edge of an application surface is provided. The method includes providing the sheet material application tool comprising at least one base portion comprising a first base gripping surface and a second base gripping surface and at least one edge portion at least partially extending substantially perpendicular to the second base gripping surface. The method further includes gripping the sheet material application tool at at least one of the first base gripping surface and the second base gripping surface, positioning the at least one edge portion of the sheet material application tool at the edge of the application surface, and moving the at least one edge portion of the sheet material application tool along the edge of the application surface.

### BRIEF DESCRIPTION OF THE DRAWINGS

The embodiments described herein and other features, advantages, and disclosures contained herein, and the manner of attaining them, will become apparent and the present disclosure will be better understood by reference to the following description of various exemplary embodiments of the present disclosure taken in conjunction with the accompanying drawing, wherein:

FIG. 1 is a perspective view of a sheet material application tool according to at least one embodiment of the present disclosure;

FIG. 2 is a perspective view of a sheet material application tool according to at least one embodiment of the present disclosure;

FIG. 3 is a perspective view of a sheet material application tool according to at least one embodiment of the present disclosure;

FIG. 4 is a perspective view of a sheet material application tool according to at least one embodiment of the present disclosure;

FIG. 5 illustrates an application surface following cutting with the sheet material application tool according to at least one embodiment of the present disclosure;

FIG. 6 is a perspective view of a sheet material application tool according to at least one embodiment of the present disclosure;

FIG. 7 illustrates a method of cutting sheet material according to at least one embodiment of the present disclosure; and

FIG. 8 illustrates a method of using a sheet material application tool according to at least one embodiment of the present disclosure.

### DETAILED DESCRIPTION

For the purposes of promoting an understanding of the principles of the present disclosure, reference will be made to the embodiments illustrated in the drawings, and specific language will be used to describe the same. It will nevertheless be understood that no limitation of the scope of this disclosure is thereby intended.

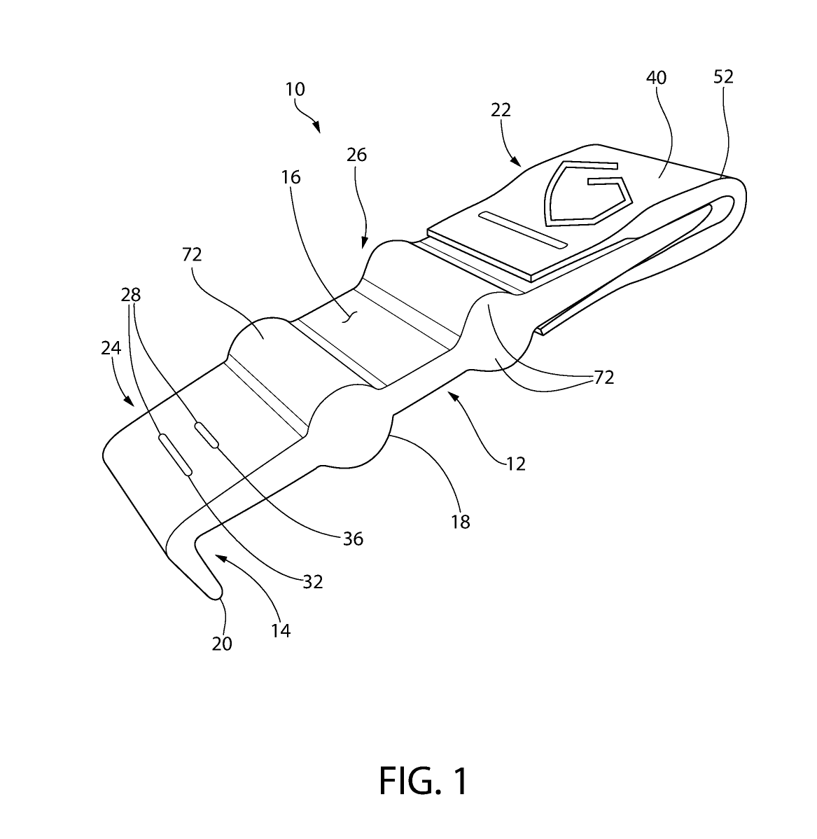

The present disclosure includes disclosure of adhesive sheet material application squeegees and methods for using the same. FIG. 1 shows a sheet material application tool 10 according to an embodiment of the present disclosure. The embodiment of the sheet material application tool 10 shown in FIG. 1 comprises a base portion 12 and an edge portion 14. In additional embodiments not illustrated, the sheet material application tool 10 includes more than one base portion 12 and/or more than one edge portion 14. The base portion 12 includes a first base gripping surface 16 and a second base gripping surface 18.

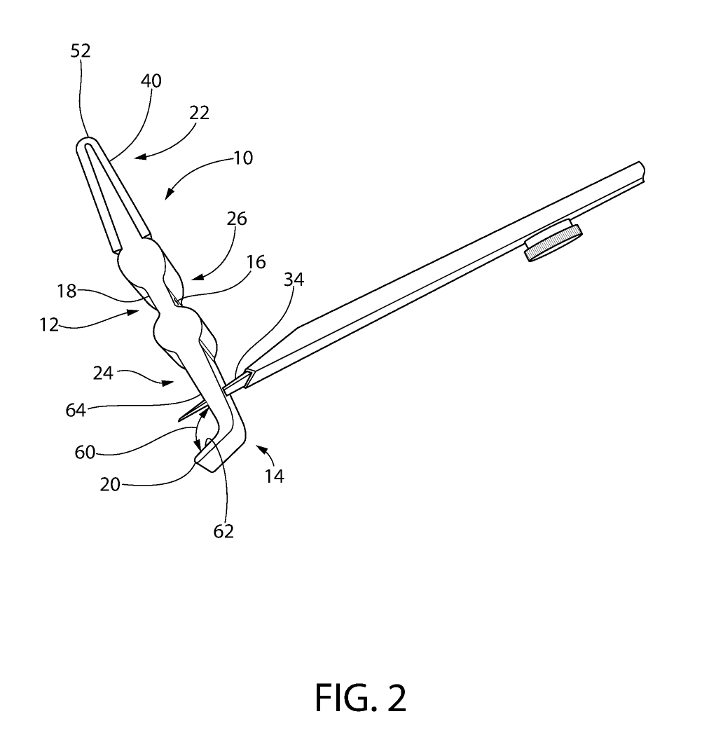

Referring now also to FIG. 2, in at least one embodiment, at least a portion of the edge portion 14 extends substantially perpendicularly to the first base gripping surface 16 and the second base gripping surface 18 forming an angle 60 between an inner edge portion surface 62 and an inner base portion surface 64 that is substantially equal to 90 degrees. In additional embodiments, the angle 60 falls in the range between 30 degrees and 150 degrees, the angle 60 falls in the range between 60 and 120 degrees, or the angle 60 falls in the range between 75 and 105 degrees. In the illustrated embodiment, the base portion 12 joins the end portion 14 at the bend forming the angle 60. In additional embodiments not illustrated, the edge portion 14 extends in a direction not perpendicular to and not parallel with a plane defined by either the first base gripping surface 16 or the second base gripping surface 18. Further, the edge portion 14 may include one or more additional portions (not shown) that extend(s) in a direction not perpendicular to and/or not parallel with a plane defined by either the first base gripping surface 16 or the second base gripping surface 18. As illustrated in FIGS. 1 and 2, additional gripping surfaces are disposed at additional areas of the tool 10, such as the right and left sides of the base portion 12 or the edge portion 14. One or more gripping ridges 72 are disposed at the first and second base gripping surfaces 16, 18, and/or at other gripping surfaces in additional embodiments not shown. The one or more gripping ridges 72 define the thickest portion(s) of the tool 10 in an embodiment. Further, in additional embodiments not illustrated, the tool 10 may be tapered overall or include one or more tapered portions when viewed orthogonally to the second base gripping portion 18.

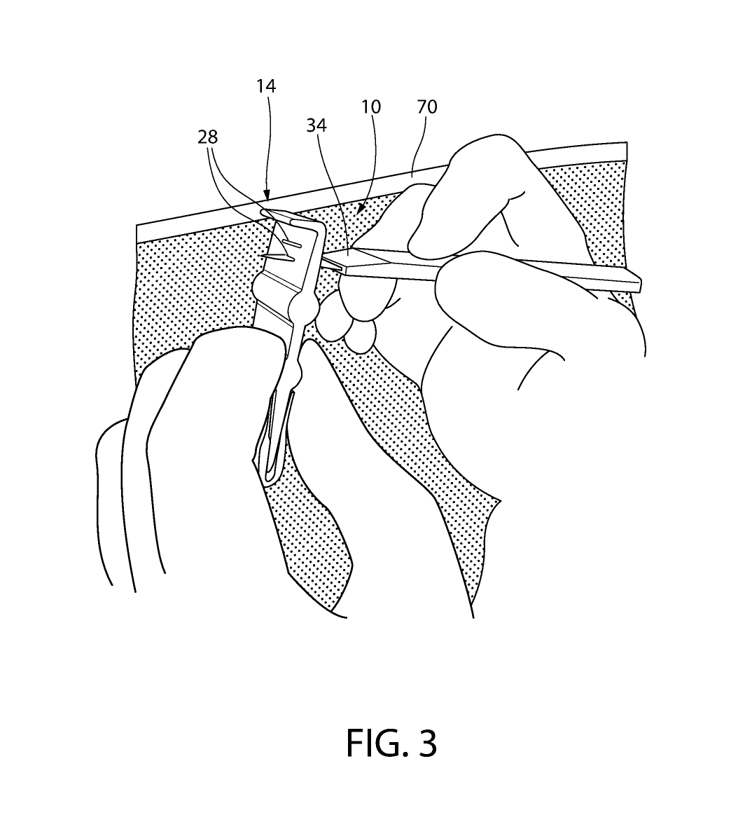

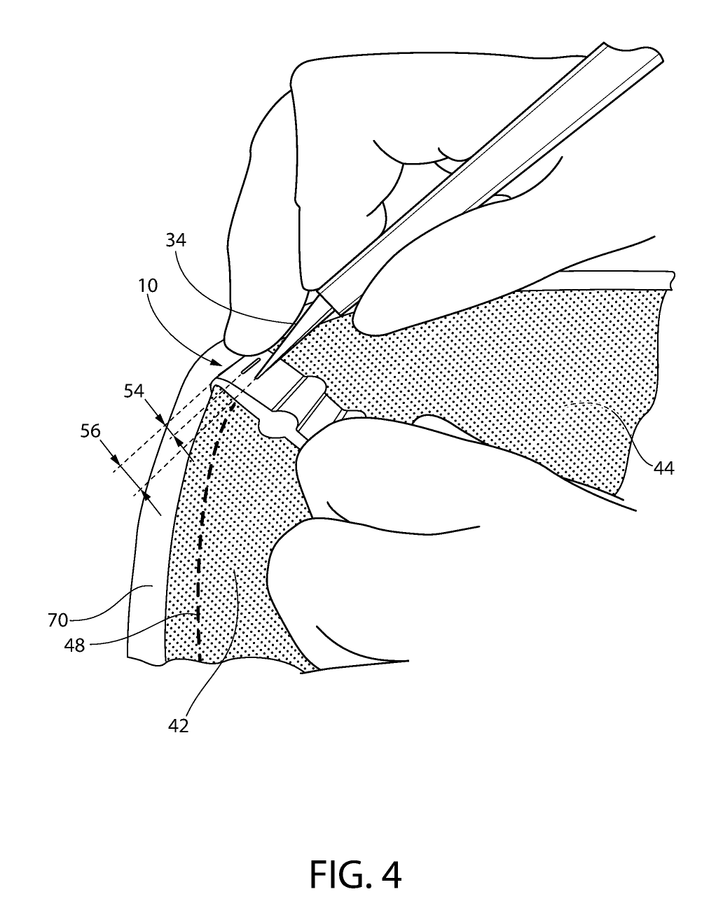

With reference now to FIGS. 3 and 4, with continuing reference to FIG. 2, the edge portion 14 includes an edge 20 spaced from the base portion 12. The edge 20 may be flat, as illustrated in one or more embodiments, or may be curved at one or more portions to form an arc, semicircle, or rounded corner(s). The edge 20 includes a radius smaller than one or more edges of the base portion 12 and/or is of a reduced thickness as compared to the base portion 12 such that the edge 20 is configured to fit along an edge 70 of an application surface 44 or within a groove, crevice, ridge, or other surface feature. As used herein, the edge 70 may also be a groove, crevice, ridge, or other surface feature having an edge, corner, or radius.

As illustrated in FIG. 1, the base portion 12 includes a first base end 22 distal to the edge portion 14, a second base end 24 proximate to the edge portion 14, and a central base portion 26 disposed between the first base end 22 and the second base end 24. In the embodiment of FIG. 1, one or more cover(s) 40 is secured over the first base end 22. The cover 40 illustrated in FIG. 1 is made from a compliant material, such as a microfiber material to name one non-limiting example. In one or more embodiments, the tool 10 illustrated in FIG. 1 may be made from a polymer, such as a nylon, polytetrafluoroethylene, another plastic material, metal, ceramic, elastomer, and/or one or more natural or synthetic materials, to name non-limiting examples. One having ordinary skill in the art will recognize the various materials that may be utilized for the cover 40 and/or any other part or portion of the tool 10 having a friction sufficiently low to allow the tool 10 and/or the cover 40 to slide or move across a sheet material 42 and a flexibility sufficiently high to allow the tool 10 and/or the cover 40 to access edges, grooves, crevices, and other surface features of the sheet material 42 and/or the application surface 44, and such materials form part of the present disclosure. The cover 40 is sewn onto the base portion 12 of the tool 10 in the embodiments illustrated. In additional embodiments not illustrated, the cover 40 is integral with the tool 10 or coupled to the tool 10 via adhesive, fastener, tension, interference, or other means recognized by one having ordinary skill in the art.

As illustrated in FIG. 1, the base portion 12 includes one or more blade accepter(s) 28 disposed at the second base end 24 and configured to accept one or more blade member(s) 30, illustrated in FIGS. 2-4. The one or more blade member(s) 30 may include a razor blade, a knife, heating element, laser, or any other object known by a person having ordinary skill in the art being capable of cutting a piece of sheet material. In the embodiment illustrated in FIG. 1, with reference to FIG. 2, the base portion 12 includes a first blade accepter 32 disposed at the second base end 24 and configured to accept a first blade member 34 and the second blade accepter 36 disposed at the second base end 24 and configured to accept the first blade member 24 and/or a second blade member (not shown). The first blade member 34 may be larger in size than the second blade member (not shown), but the first blade member 34 is smaller than, or substantially equal in size to, the second blade member (not shown) in additional embodiments.

The first blade accepter 32 and/or the second blade accepter 36 is a slot through the sheet material application tool 10. The first blade accepter 32 is disposed a first edge distance 54 from the inner edge portion surface 62, and the second blade accepter 34 is disposed a second edge distance 56 from the inner edge portion surface 62. In the embodiment illustrated, the first edge distance 54 is ⅛″, and the second edge distance 56 is ¼″. The first edge distance 54 and/or the second edge distance 56 of additional embodiments include any distance capable of spacing a cutting line 48 from the edge 70 of the application surface 44. In additional embodiments not illustrated, any blade accepter(s) 28 or any number of blade accepters 28 may be disposed at another location of the tool 10 and/or configured to include a structure different from a slot, including, without limitation, simply a notch or groove on a side edge of the tool 10 capable of accepting a blade member 30. In additional embodiments not illustrated, the tool 10 does not include the edge portion 14, but the base portion 12 includes the one or more blade accepter(s) 28 disposed at the second base end 24 configured to accept one or more blade member(s) 30. In an embodiment where the tool 10 does not include the edge portion 14, the second base end 24 terminates at a straight, curved, rounded or another type of edge to form an end of the base portion 12.

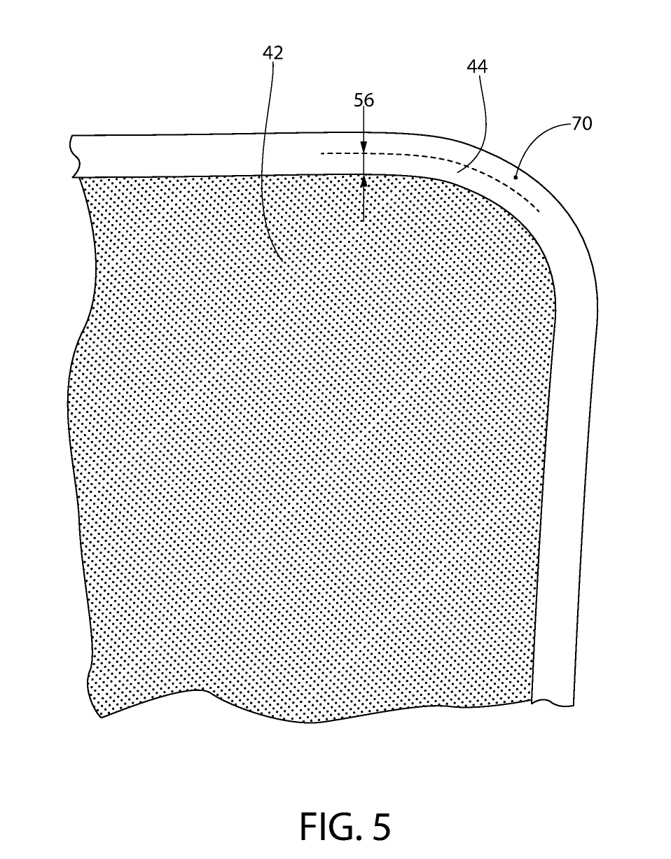

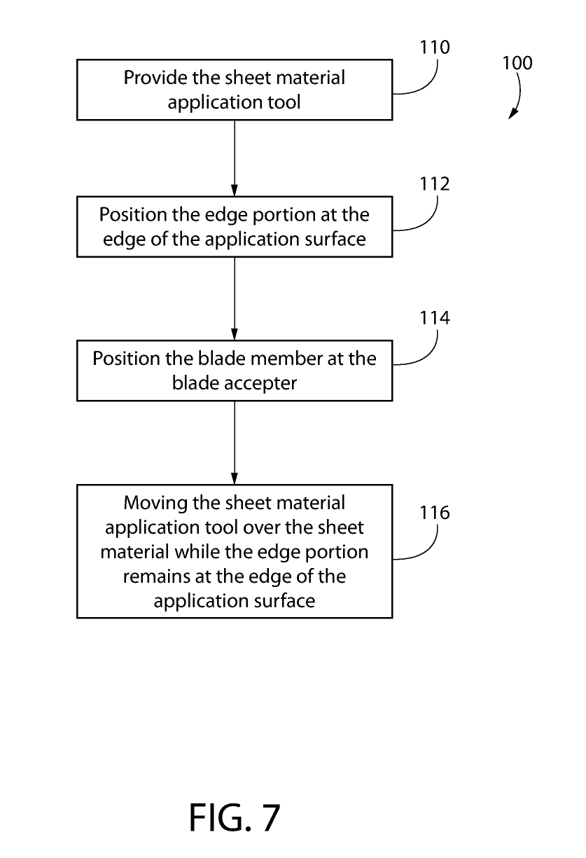

Referring to FIGS. 3-5 and 7, in an embodiment of the present disclosure, a method 100 of cutting sheet material adjacent an edge 70 of the application surface 44 is provided. The method 100 of an embodiment includes providing, at step 110, the sheet material application tool 10 having the edge portion 14 and the blade accepter 28. The method 100 may further include, in particular embodiments, applying the sheet material 42 to the application surface 44. In an embodiment, the application surface 44 is a window or other application surface having an edge adjacent thereto. The method 100 of an embodiment further includes positioning, at step 112, the edge portion 14 of the sheet material application tool 10 at the edge 70 of the application surface 44. The method 100 of an embodiment further includes positioning, at step 114, the blade member 30 at a blade accepter 28 such that the blade member 30 contacts the sheet material 42 through the blade accepter 28 of the sheet material application tool 10, as best illustrated in FIGS. 3 and 4. The method 100 further includes moving, at step 116, the sheet material application tool 10 over the sheet material 42 while the edge portion 14 of the sheet material application tool 10 remains at the edge 70 of the application surface 44 such that the blade member 28 cuts sheet material 42 at the application surface 44. As recited herein, cutting the sheet material 42 at the application surface 44, adjacent to the edge 70, and/or along the edge 70 includes cutting parallel to the edge 70 and/or cutting a distance from the edge 70 a predetermined distance from the edge 70, including a predetermined distance substantially equal to the first edge distance 54 or the second edge distance 56.

The method 100 of an embodiment includes securing sheet material 42 to the application surface 44 over the edge 70 of the application surface 44, such as before cutting sheet material 42 at the application surface 44. The method 100 of an embodiment includes cutting the sheet material 42 along the cutting line 48 spaced from the edge 70 of the application surface 44.

Referring now to FIGS. 1, 2, 6, and 8, in accordance with an embodiment of the present disclosure, a method 200 of using the sheet material application tool 10 adjacent the edge 70 of the application surface 44 is provided. The method 200 of an embodiment includes providing, at step 210, the sheet material application tool 10. The method 200 of an embodiment includes gripping, in step 212, the sheet material application tool 10 at the first base gripping surface 16 and/or the second base gripping surface 18. The method 200 of an embodiment includes positioning, at step 214, the edge portion 14 of the sheet material application tool 10 at the edge 70 of the application surface 44. The method 200 in an embodiment includes moving, at step 216, the edge portion 14 of the sheet material application tool 10 along the edge 70 of the application surface 44. In additional embodiments, the method 200 includes moving the edge portion 14 along the edge 70 proximate the edge 70, through the edge 70, and/or in the edge 70.

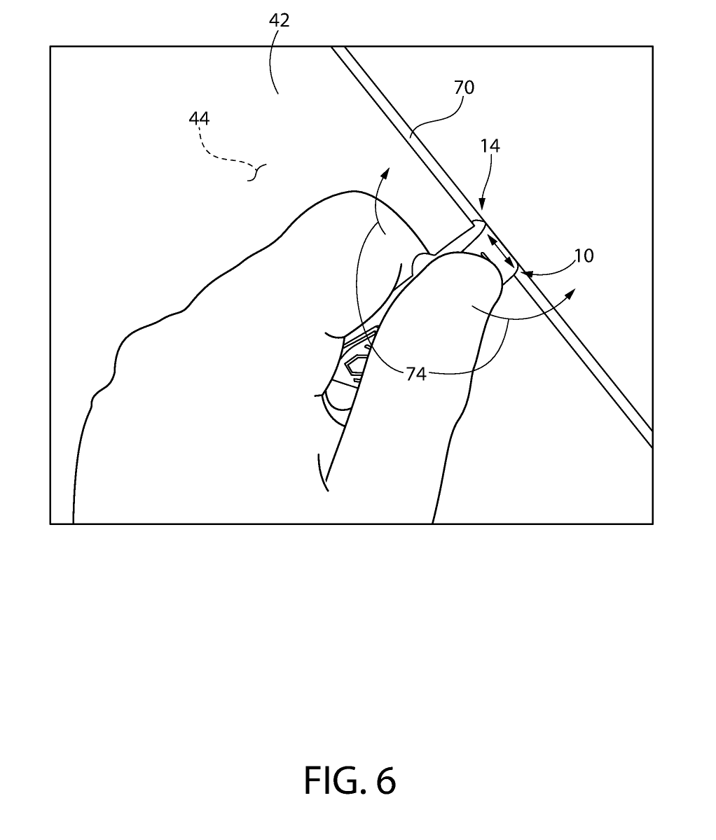

The method 200 of an embodiment includes securing the sheet material 42 to the application surface 44 at the edge 70 using the edge portion 14 of the sheet material application tool 10. As illustrated in FIG. 6, in an embodiment, securing the sheet material 42 to the application surface 44 at the edge 70 with the edge portion 14 of the sheet material application tool 10 includes moving the base portion 12 toward and away from the application surface 44, as indicated by arrows 74 in FIG. 6. The method 200 of an embodiment includes positioning a flexible member (not shown) at the edge portion 14. In an embodiment, the flexible member is a cloth or other fabric material. In additional embodiments, the flexible member is a sponge, tissue paper, or any other material one having ordinary skill in the art would recognize as being capable of being positioned around the edge 70 for insertion into or application against the edge 70 of the application surface 44. The flexible member may include a cleaning cloth with or without a detergent or another cleaning agent to remove dirt, debris, and other substances from in and/or around the edge 70 of the application surface 44 and/or another portion of the application surface 44. The flexible member is positioned between the edge portion 14 and the edge 70 before the tool 10 pushes or otherwise positions at least a portion of the flexible member at the edge 70, in the edge 70, or along the edge 70. Moving the edge portion 14 of the sheet material application tool 10 along the edge 70 of the application surface 44 may include moving the flexible member 50 along the edge 70 of the application surface 44. In an embodiment, moving the flexible member 50 along the edge 70 of the application surface 44 includes at least partially cleaning the edge 70 of the application surface 44 with the flexible member 50.

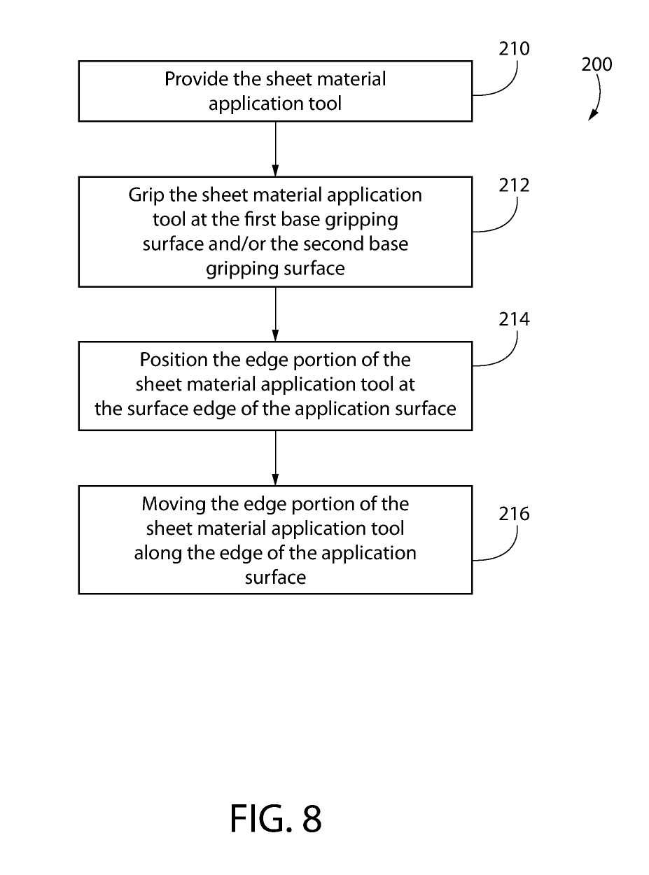

Referring again to FIG. 1 with continuing reference to FIGS. 6 and 8, in an embodiment, the base portion 12 further includes the first base end 22 having a first base end edge 52 and being distal from the edge portion 14. The first base end edge 20 may be flat, as illustrated in one or more embodiments, or may be curved at one or more portions to form an arc, semicircle, or rounded corner(s). In an embodiment, the method 200 includes positioning the first base end edge 52 of the first base end 22 of the sheet material application tool 10 at the edge 70 of the application surface 44 to secure sheet material 42 to the application surface 44 at the edge 70 of the application surface 44. In an embodiment, the method 200 includes moving the first base end edge 52 of the first base end 22 of the sheet material application tool 10 along the edge 70 of the application surface 44 to secure sheet material 42 to the application surface 44 at the edge 70 of the application surface 44.

While various embodiments of a sheet material application tool and methods for using the same have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure.

What is claimed is:

1. A sheet material application tool comprising:
at least one base portion comprising:
a first base gripping surface; and
a second base gripping surface; and
at least one edge portion extending substantially perpendicular to the second base gripping surface.

2. The sheet material application tool of claim 1, wherein the at least one edge portion includes at least one edge spaced from the at least one base portion.

3. The sheet material application tool of claim 1, wherein the at least one base portion includes:
a first base end distal to the at least one edge portion;
a second base end proximate to the at least one edge portion; and
a central base portion disposed between the first base end and the second base end.

4. The sheet material application tool of claim 3, wherein the at least one base portion includes at least one blade accepter disposed at the second base end and configured to accept at least one blade member.

5. The sheet material application tool of claim 4, wherein the at least one base accepter includes a first blade accepter disposed at the second base end and configured to accept a first blade member and a second blade accepter disposed at the second base end and configured to accept a second blade member.

6. The sheet material application tool of claim 5, wherein the first blade member is larger in size than the second blade member.

7. The sheet material application tool of claim 5, wherein at least one of the first blade accepter and the second blade accepter is a slot through the sheet material application tool.

8. The sheet material application tool of claim 3, further comprising at least one cover, wherein the at least one cover is secured over the first base end.

9. The sheet material application tool of claim 8, wherein the at least one cover is sewn onto the at least one base portion.

10. A method of cutting sheet material adjacent an edge of an application surface, the method comprising:
providing a sheet material application tool having an edge portion and a blade accepter;
positioning the edge portion of the sheet material application tool at the edge of the application surface;
positioning a blade member at the blade accepter such that the blade member contacts the sheet material through the blade accepter of the sheet material application tool; and
moving the sheet material application tool over the sheet material while the edge portion of the sheet material application tool remains at the edge of the application surface such that the blade member cuts sheet material at the application surface.

11. The method of claim 10, further comprising securing the sheet material to the application surface over the edge of the application surface.

12. The method of claim 11, further comprising cutting the sheet material along a cutting line spaced from with the edge of the application surface.

13. A method of using a sheet material application tool adjacent an edge of an application surface, the method comprising:
providing the sheet material application tool comprising:
at least one base portion comprising a first base gripping surface and a second base gripping surface; and
at least one edge portion at least partially extending substantially perpendicular to the second base gripping surface;
gripping the sheet material application tool at at least one of the first base gripping surface and the second base gripping surface;
positioning the at least one edge portion of the sheet material application tool at the edge of the application surface; and
moving the at least one edge portion of the sheet material application tool along the edge of the application surface.

14. The method of claim 13, further comprising securing the sheet material to the application surface at the edge with the at least one edge portion of the sheet material application tool.

15. The method of claim 14, wherein securing sheet material to the application surface at the edge with the at least one edge portion of the sheet material application tool includes moving the at least one base portion toward and away from the application surface.

16. The method of claim 13, further comprising positioning a flexible member at the at least one edge portion, wherein moving the at least one edge portion of the sheet material application tool along the edge of the application surface includes moving the flexible member along the edge of the application surface.

17. The method of claim 16, wherein moving the flexible member along the edge of the application surface includes at least partially cleaning the edge of the application surface with the flexible member.

18. The method of claim 13, wherein the at least one base portion further comprises a first base end having a first base end edge and being distal from the at least one edge portion.

19. The method of claim 18, further comprising positioning the first base end edge of the first base end of the sheet material application tool at the edge of the application surface to secure sheet material to the application surface at the edge of the application surface.

20. The method of claim 19, further comprising moving the first base end edge of the first base end of the sheet material application tool along the edge of the application surface to secure sheet material to the application surface at the edge of the application surface.
